(19) United States
(12) Patent Application Publication
(10) Pub. No.: US 2016/0222908 A1
(43) Pub. Date: Aug. 4, 2016

(54) FLUID CONTROL SYSTEM AND METHOD OF MAKING AND USING THE SAME

(71) Applicant: GM Global Technology Operations LLC, Detroit, M (US)

(72) Inventors: Alan Martin, Metamora, MI (US); Joseph T. Dipardo, Niagara Falls, CA (US)

(21) Appl. No.: 14/614,041

(22) Filed: Feb. 4, 2015

(51) Int. Cl. F02F 1/24

(52) U.S. Cl. CPC F02F 1/24

(57) ABSTRACT

A number of variations may include a product including a fluid control system comprising a bore and at least one bead, wherein the bead is constructed and arranged to control the amount of fluid between a first location and a second location in or on at least one component.

### TECHNICAL FIELD

The field to which the disclosure generally relates to includes fluid control systems and methods of making and using the same.

### BACKGROUND

Currently, some components contain fluids and control systems for controlling flow of those fluids within those components.

### SUMMARY OF ILLUSTRATIVE VARIATIONS OF THE INVENTION

A number of variations may include a product including a fluid control system comprising at least one bore and at least one bead, wherein the bead may be constructed and arranged to control the amount of fluid between a first location and a second location in or on at least one component.

A number of variations may include a method including providing at least one component comprising a bore and a bead; providing fluid flow through the bore and the bead wherein the bead may be constructed and arranged to control the amount of fluid between a first location and a second location in or on at least one component.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is an illustration of a product according to a number of variations.

FIG. 2 is an illustration of a product according to a number of variations.

FIG. 3 is an illustration of a product and method according to a number of variations.

FIG. 4 is an illustration of a product and method according to a number of variations.

FIG. 5 is an illustration of a product and method according to a number of variations.

FIG. 6 is an illustration of a method according to a number of variations.

### DETAILED DESCRIPTION OF ILLUSTRATIVE VARIATIONS OF THE INVENTION

The following description of the variations is merely illustrative in nature and is in no way intended to limit the invention, its application, or uses.

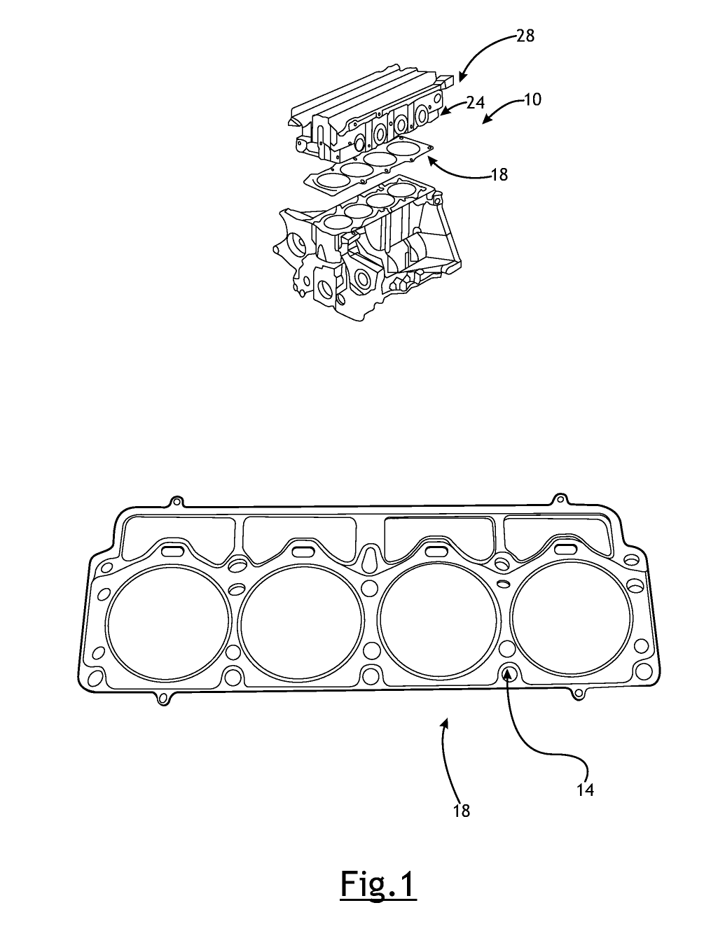

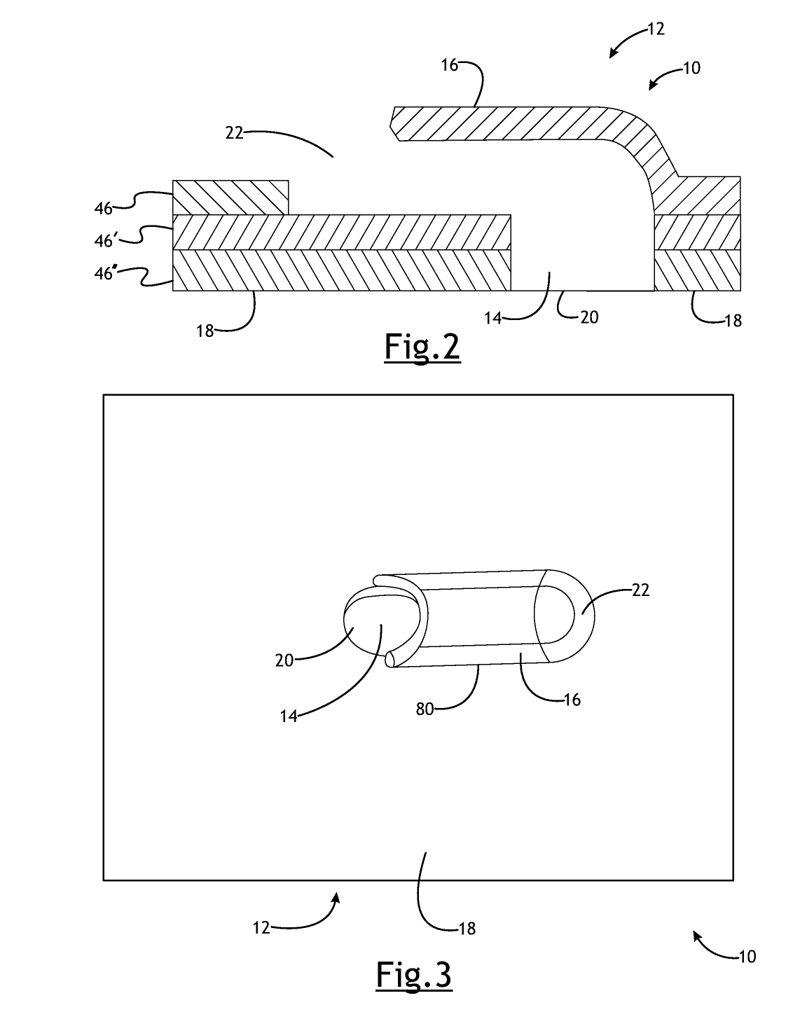

FIGS. 1-3 show an illustration of a product 10 according to a number of variations. In a number of variations, the product 10 may include a fluid control system 12. In a number of variations, the fluid control system 12 may include at least one bore 14 and at least one bead 16. In a number of variations, the bead 16 may be constructed and arranged to control the amount of fluid between a first location 20 and a second location 22 on or in at least one component 18. In a number of variations, the bead 16 may be fluidly connected to a second component 28 that may include a third location 24. In a number of variations, the fluid connection may be in the form of a tube or gallery. In a number of variations, fluid may flow from the first component 18 first location 20 to a third location 24 on or in the second component 28 or vice versa. In a number of variations, the fluid control system 12 may meter or limit fluid flow to what may be deemed necessary for the specific component and its application.

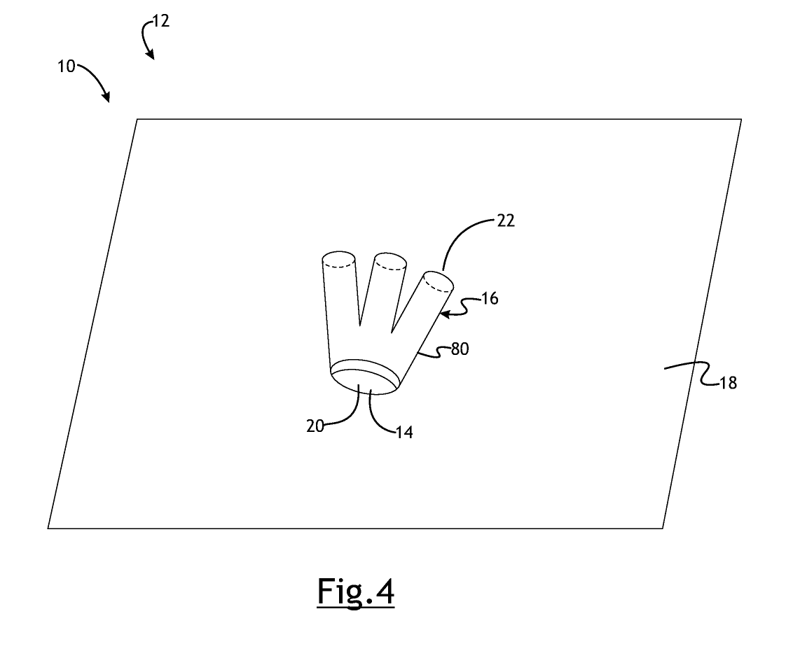

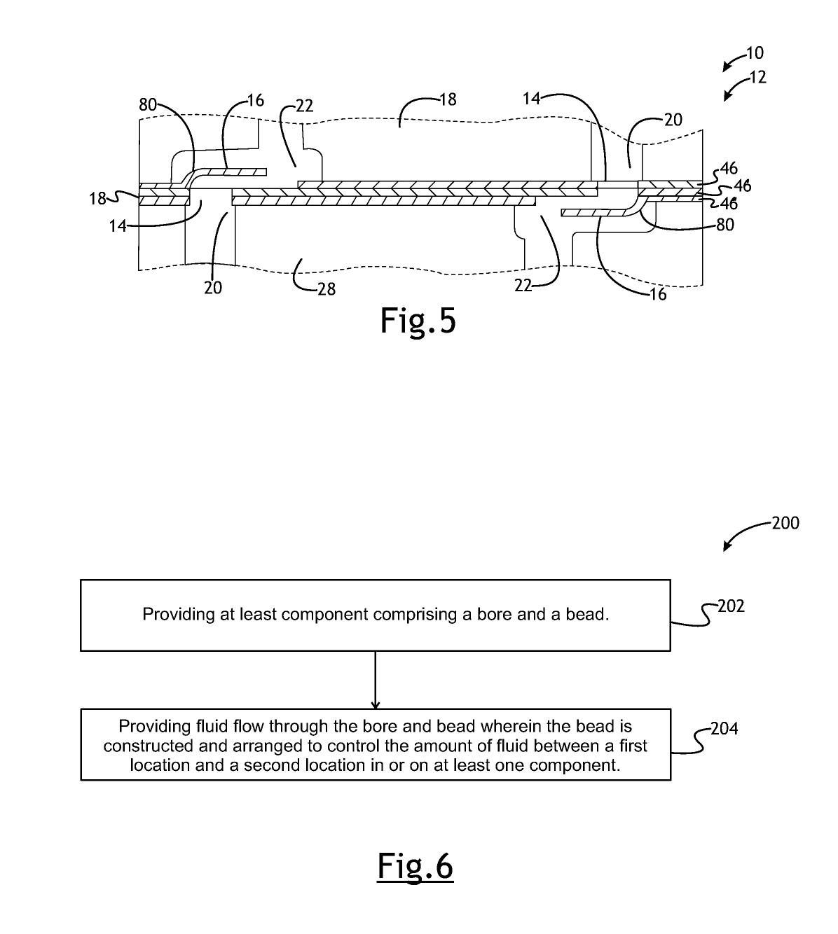

In a number of variations, the bead 16 may be uncompressed. In a number of variations, the bead 16 may be in the shape of a hollow half cylinder. In a number of variations, the bead 16 may be a number of different shapes to fit its desired application, including, but not limited to, a hollow half cone, a hollow cube, a hollow cuboid, a hollow 3-D shape with a polygonal cross-section, a hollow half pyramid, a hollow prism, or may be another type. In a number of variations, the bead 16 may be tapered along its length. In a number of variations, the bead 16 may be filled in for a narrower cross section at points along its length. In a number of variations, the bead 16 may be constructed to fit its desired application. As shown in FIG. 4, in a number of variations, the bead 16 may comprise multiple branches 30. In a number of variations, the branches 30 may direct fluid to or from several locations in or on several different components. In a number of variations, “in” or “on” may be defined as being interior to, exterior to, next to, adjacent to, or on the surface of at least one component 18. In a number of variations, the radius of the bead 16 may be greater than ¼ millimeters. In a number of variations, the radius of the bead 16 may be greater than ½ millimeters. In a number of variations, the radius of the bead 16 may be greater than ¾ millimeters. In a number of variations, the radius of the bead 16 may be greater than a 1 millimeter. In a number of variations, the radius of the bead 16 may be tightly controlled to a range of +/−20 microns. In a number of variations, the bead 16 may be formed as part of the first component 18. In a number of variations, the bead 16 may be formed as part of the first component 18 through metal forming, forging, molding, flow forming, rolling, extrusion, laser cladding, metalworking, sintering, machining, or fabrication. In a number of variations, the bead 16 may be attached to the first component 18 through an attachment 80. In a number of variations the attachment 80 may comprise an adhesive comprising acrylonitrile, cyanoacrylate, acrylic, resorcinol glue, epoxy resin, epoxy putty, ethylene-vinyl acetate, phenol formaldehyde resin, polyamide, polyester, polyethylene, polypropylene, polysulfides, polyurethane, polyvinyl acetate, polyvinyl alcohol, polyvinyl chloride, polyvinyl chloride emulsion, polyvinylpyrrolidone, rubber cement, silicone, or may be another type. In a number of variations, the attachment 80 may comprise a process including, but not limited to, welding, molding, brazing, casting, extrusion, forging, heat treatment, hydroforming, punching, shearing, spinning, or may be attached another way.

In a number of variations, the bead 16 may comprise a metallic material. In a number of variations, the bead 16 may comprise a polymeric material. In a number of variations, the bead 16 may comprise a ceramic material. In a number of variations, the bead 16 may comprise a fibrous material. In a number of variations, the bead 16 may comprise a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, combinations thereof, or may be another type.

In a number of variations, the fluid control system 12 may include at least one component 18. In a number of variations, the fluid control system 12 may include multiple components (18, 28, 38 . . . ). In a number of variations, the component 18 may be formed through casting (including sand casting, investment casting, die casting, or continuous casting), forging, flow forming, rolling, extrusion, laser cladding, metalworking, sintering, molding, machining, or fabrication. In a number of variations, the component 18 may comprise a metallic material including known alloys. In a number of variations, the component 18 may comprise a polymeric material. In a number of variations, the component 18 may comprise a ceramic material. In a number of variations, the component 18 may comprise a fibrous material. In a number of variations, the component 18 may comprise a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), alloys, combinations thereof, or may be another type. In a number of variations, a first component 18 may be in contact with and/or in fluid communication with a second component 28. In a number of variations, the second component 28, may be formed or otherwise machined to form a compartment 90 to accept the bead 16 of the first component 18. In a number of variations, the first component 18 may comprise an engine head gasket of a vehicle. In a number of variations, the head gasket component 18 may comprise multiple layers 46. In a number of variations, the fluid control system 12 may include a head gasket component 18 for moving an engine fluid from a first location 20 to a second location 22. In a number of variations, the second component 28 may comprise an engine cylinder head of a vehicle. In a number of variations, the fluid control system 12 may include a head gasket component 18 and an engine cylinder head component 28 for moving an engine fluid from a second location 22 on the head gasket component 18 to a third location 24 in or on the engine cylinder head component 28. In a number of variations, the fluid may be a Newtonian or non-Newtonian fluid. In a number of variations, the fluid may be an engine fluid for a vehicle. In a number of variations the fluid may include, but is not limited to, oil, gasoline, engine coolant, water, brake fluid, transmission fluid, power steering fluid, battery fluid, or windshield wiper fluid, or may be another type. In a number of variations, the fluid control system 12 and/or bead 16 may allow for small steam passages for fluid coolant to allow air to escape without losing large amounts of coolant.

In a number of variations, the bore 14 be formed on or in the first component 18 by machining including, but not limited to, casting (including sand casting, investment casting, die casting, or continuous casting), forging, flow forming, drilling, rolling, extrusion, laser cladding, piercing, metalworking, sintering, machining, or fabrication. In a number of variations, the bore 14 may be cut through several layers 46 (46′, 46″) of material within the first component 18. In a number of variations, the layers 46 (46′, 46″) may include at least one steel layer. In a number of variations, the layers 46 (46′, 46″) may include at least two steel layers. In a number of variations, the layers 46 (46′, 46″) may include at least three steel layers. In a number of variations, the bore 14 may connect fluid from a first location in or on the first component 18 to the bead 16. The bore 14 may have a circular cross-section. The bore 14 may have a cross-section that comprises an oval, a circle, or a polygonal shape including, but not limited to, a parallelogram, a pentagon, a hexagon, a heptagon, an octagon, a nonagon, a decagon, a triangle, or may be another type. The bore 14 may be any shape to fit its desired application. The bore 14 may be tapered along its length. In a number of variations, the bore 14 may be offset or skewed along its length in relation to normal. In a number of variations, the bore 14 may start at a first 20 location in or on the first component 18. In a number of variations, the cross-sectional radius of the bore 14 may be greater than 0.65 millimeters. In a number of variations, the cross-sectional radius of the bore 14 may be greater than 0.75 millimeters. In a number of variations, the cross-sectional radius of the bore 14 may be greater than 0.85 millimeters. In a number of variations, the cross-sectional radius of the bore 14 may be greater than 1 millimeter. In a number of variations, the cross-sectional radius of the bore 14 may be tightly controlled to +/−20 microns. In a number of variations, the cross-sectional radius of the bead 16 may be less than the cross-sectional radius of the bore 14. In a number of variations, the fluid control system 12 may include a first component 18 comprising a head gasket wherein the bore 14 and the bead 16 may be used to meter or limit oil flow to a second component 28 engine cylinder head to approximately what may be deemed necessary for that second component 28. In a number of variations, the bore 14 may comprise an oil gallery. In a number of variations, the fluid control system 12 may eliminate the need for a separately machined oil restrictor piece. In a number of variations, the bead 16 may connect two offset sections of the bore 14 of the head gasket.

FIG. 6 illustrates a method 200 according to a number of variations. In a number of variations, a method 200 may be shown wherein the method 200 includes a step 202 of providing at least one component 18 comprising a bore 14 and a bead 16. The method further includes a step 204 of providing fluid flow through the bore 14 and the bead 16 wherein the bead 16 may be constructed and arranged to control the amount of fluid between a first location 20 and a second location 22 in or on at least one component 18. In a number of variations, the method 200 further includes providing a second component 28 fluidly connected to the bead 16, and providing fluid flow from the bead 16 to a third location 24 located in or on the second component 28. In a number of variations, the method 200 includes wherein the fluid is flown first through the bore 14 and then the bead 16. In a number of variations, the method 200 includes wherein the fluid is flown first through the bead 16 and then the bore 14.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising a fluid control system comprising at least one bore and at least one bead, wherein the bead is constructed and arranged to control the amount of fluid between a first location and a second location in or on at least one component.

Variation 2 may include a product as set forth in Variation 1 wherein said bead comprises a hollow half cylinder.

Variation 3 may include a product as set forth in any of Variations 1-2 wherein the radius of said bead is great than a ¼ millimeter.

Variation 4 may include a product as set forth in any of Variations 1-3 wherein said bead comprises multiple branches.

Variation 5 may include a product as set forth in any of Variations 1-4 wherein said bead has a smaller radius than the radius of the bore.

Variation 6 may include a product as set forth in any of Variations 1-5 wherein said bead is tapered along its length

Variation 7 may include a product as set forth in any of Variations 1-6 wherein said component is an engine head gasket.

Variation 8 may include a product as set forth in Variation 7 wherein said bore is drilled into said gasket.

Variation 9 may include a product as set forth in any of Variations 7-8 wherein said bead is formed on the top surface of said gasket.

Variation 10 may include a product as set forth in any of Variations 7-9 wherein said gasket comprises multiple layers.

Variation 11 may include a method including providing at least one component comprising a bore and a bead; providing fluid flow through the bore and the bead wherein the bead is constructed and arranged to control the amount of fluid between a first location and a second location in or on at least one component.

Variation 12 may include a method as set forth in Variation 11 further comprising providing a second component fluidly connected to the bead; providing fluid flow from the bead to a third location located in or on the second component.

Variation 13 may include a method as set forth in any of Variations 11-12 wherein said bead comprises a hollow half cylinder.

Variation 14 may include a method as set forth in any of Variations 11-13 wherein the radius of said bead is greater than a ¼ millimeter.

Variation 15 may include a method as set forth in any of Variations 11-14 wherein said bead comprises multiple branches.

Variation 16 may include a method as set forth in any of Variations 11-15 wherein said bead has a smaller radius than the radius of the bore.

Variation 17 may include a method as set forth in any of Variations 11-16 wherein said bead is tapered along its length

Variation 18 may include a method as set forth in any of Variations 11-17 wherein said first component is an engine head gasket.

Variation 19 may include a method as set forth in any of Variations 17-18 wherein said bore is drilled into said gasket.

Variation 20 may include a method as set forth in any of Variations 17-19 wherein said bead is formed on the top surface of said gasket.

Variation 21 may include a method, and/or a product as set forth in any of Variations 1-20 wherein the fluid control system may meter or limit fluid flow to what is necessary for the specific component and its application.

Variation 22 may include a method, and/or a product as set forth in any of Variations 1-21 wherein the bead is uncompressed.

Variation 23 may include a method, and/or a product as set forth in any of Variations 1-22 wherein the bead forms the shape of a hollow half cone, a hollow cube, a hollow cuboid, a hollow 3-D shape with a polygonal cross-section, a hollow half pyramid, or a hollow prism.

Variation 24 may include a method, and/or a product as set forth in any of Variations 1-23 wherein the bead is filled in for a narrower cross section at points along its length.

Variation 25 may include a method, and/or a product as set forth in any of Variations 1-24 wherein the bead branches directs fluid to or from several locations in or on several different components.

Variation 26 may include a method, and/or a product as set forth in any of Variations 1-25 wherein the radius of the bead is tightly controlled to a range of +/−20 microns.

Variation 26 may include a method, and/or a product as set forth in any of Variations 1-25 wherein the bead is formed as part of the first component through casting (including sand casting, investment casting, die casting, or continuous casting), forging, molding, flow forming, rolling, extrusion, laser cladding, metalworking, sintering, machining, or fabrication.

Variation 27 may include a method, and/or a product as set forth in any of Variations 1-26 wherein the bead is attached to the first component 18 through an attachment.

Variation 28 may include a method, and/or a product as set forth in any of Variations 1-27 wherein the attachment comprises an adhesive comprising acrylonitrile, cyanoacrylate, acrylic, resorcinol glue, epoxy resin, epoxy putty, ethylene-vinyl acetate, phenol formaldehyde resin, polyamide, polyester, polyethylene, polypropylene, polysulfides, polyurethane, polyvinyl acetate, polyvinyl alcohol, polyvinyl chloride, polyvinyl chloride emulsion, polyvinylpyrrolidone, rubber cement, silicone, or may be another type.

Variation 29 may include a method, and/or a product as set forth in any of Variations 1-28 wherein the attachment comprises a process including welding, molding, brazing, casting, extrusion, forging, heat treatment, hydroforming, punching, shearing, or spinning.

Variation 30 may include a method, and/or a product as set forth in any of Variations 1-29 wherein the bead comprises a metallic material.

Variation 31 may include a method, and/or a product as set forth in any of Variations 1-30 wherein the bead comprises a polymeric material.

Variation 32 may include a method, and/or a product as set forth in any of Variations 1-31 wherein the bead comprises a ceramic material.

Variation 33 may include a method, and/or a product as set forth in any of Variations 1-32 wherein the bead may comprise a fibrous material.

Variation 34 may include a method, and/or a product as set forth in any of Variations 1-33 wherein the bead comprises a material including plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), metallic alloys, or combinations thereof.

Variation 35 may include a method, and/or a product as set forth in any of Variations 1-34 wherein the fluid control system comprises multiple components.

Variation 36 may include a method, and/or a product as set forth in any of Variations 1-35 wherein the component is formed through casting (including sand casting, investment casting, die casting, or continuous casting), forging, flow forming, rolling, extrusion, laser cladding, metalworking, sintering, molding, machining, or fabrication.

Variation 37 may include a method, and/or a product as set forth in any of Variations 1-36 wherein the component comprises a metallic material including known alloys

Variation 38 may include a method, and/or a product as set forth in any of Variations 1-37 wherein the component comprises a polymeric material.

Variation 39 may include a method, and/or a product as set forth in any of Variations 1-38 wherein the component comprises a fibrous material.

Variation 40 may include a method, and/or a product as set forth in any of Variations 1-39 wherein the component comprises a ceramic material

Variation 41 may include a method, and/or a product as set forth in any of Variations 1-40, wherein the component comprises a material including, but not limited to, plastic steel, stainless steel, copper, nickel, tin, noble metals, zinc, iron, bronze, aluminum, titanium, platinum, shellac, amber, aramid (including Twaron, Kevlar, Technora, Nomax), silk, rubber, synthetic rubber, phenol formaldehyde, neoprene, nylon, polyvinyl chloride, polystyrene, polyethylene, polypropylene, polybenzimidazoles, polyacrylonitrile, PVB, silicone, bioplastic, Teflon, PET, PP, PVDC, PA PTFE, PEO, PPY, PANT, PT, PPS, PPV, PAC, polyester, vinyl polymer, polyolefin, polyacetylene, phenolic resin, polyanhydride, epoxy, phenolic, polyimide, PEEK, alumina, beryllia, ceria, zirconia, carbide, boride, nitride, silicide, porcelain, clay, quartz, alabaster, glass, kaolin, feldspar, steatite, petuntse, ferrite, earthenware, PZT, alpaca, angora, byssus, camel hair, cashmere, catgut, chiengora, guanaco, llama, leather, mohair, pashmina, qiviut, rabbit, silk, sinew, spider silk, wool, vicuna, yak, abaca', bagasse, balsa, bamboo, coir, cotton, flax, hemp, jute, kapok, kenaf, pina, raffia, ramie, sisal, wood, asbestos, acetate, triacetate, art silk, lyocell rayon, modal rayon, rayon, glass, silica, carbon, basalt, metallic, acrylic, microfiber, modacrylic, nylon, olefin, polyester, polyethylene, spandex, vinylon, vinyon, zylon, saran, carbon-fiber-reinforced polymer, carbon-fiber-reinforced plastic, carbon-fiber reinforced thermoplastic, or carbon nanotube reinforced polymer, fiber reinforced polymer, fiberglass (including E-glass, A-glass, E-CR-glass, C-glass, D-glass, R-glass, F-glass, S-glass, S-2-glass, Hexel, or may be another type), alloys, or combinations thereof.

Variation 42 may include a method, and/or a product as set forth in any of Variations 1-41 wherein the head gasket component comprises multiple layers.

Variation 43 may include a method, and/or a product as set forth in any of Variations 10-42 wherein the fluid control system comprises a head gasket component for moving an engine fluid from a first location to a second location.

Variation 44 may include a method, and/or a product as set forth in any of Variations 10-43 wherein the fluid control system comprises a head gasket component and a second component for moving an engine fluid from a second location to a third location in or on the second component wherein the second component comprises an engine cylinder head.

Variation 45 may include a method, and/or a product as set forth in any of Variations 1-44 wherein the fluid is a Newtonian or non-Newtonian fluid.

Variation 46 may include a method, and/or a product as set forth in any of Variations 1-45 wherein the fluid comprises oil, gasoline, engine coolant, water, brake fluid, transmission fluid, power steering fluid, battery fluid, or windshield wiper fluid.

Variation 47 may include a method, and/or a product as set forth in any of Variations 1-46 wherein the fluid control system 12 and/or bead 16 allows for small steam passages for fluid coolant to allow air to escape without losing large amounts of coolant.

Variation 48 may include a method, and/or a product as set forth in any of Variations 1-47 wherein the bore is formed on or in the first component 18 by machining including, but not limited to, casting (including sand casting, investment casting, die casting, or continuous casting), forging, flow forming, drilling, rolling, extrusion, laser cladding, piercing, metalworking, sintering, machining, or fabrication.

Variation 49 may include a method, and/or a product as set forth in any of Variations 1-48 wherein the bore is cut through several layers of material within the first component.

Variation 50 may include a method, and/or a product as set forth in any of Variations 1-49 wherein the bore 14 connects fluid from a first location in or on the first component to the bead.

Variation 51 may include a method, and/or a product as set forth in any of Variations 1-50 wherein bore has a cross-section that comprises an oval, a circle, or a polygonal shape including, but not limited to, a parallelogram, a pentagon, a hexagon, a heptagon, an octagon, a nonagon, a decagon, or a triangle.

Variation 52 may include a method, and/or a product as set forth in any of Variations 1-51 wherein the bore is tapered along its length.

Variation 53 may include a method, and/or a product as set forth in any of Variations 1-52 wherein the bore is offset or skewed along its length in relation to normal.

Variation 54 may include a method, and/or a product as set forth in any of Variations 1-53 wherein the cross-sectional radius of the bore is greater than 0.65 millimeters and is tightly controlled to +/−20 microns.

Variation 55 may include a method, and/or a product as set forth in any of Variations 1-54 wherein the bore 14 starts at a first location in or on the first component.

Variation 56 may include a method, and/or a product as set forth in any of Variations 1-55 wherein the fluid control system comprises a component comprising a head gasket wherein the bore and the bead are used to meter or limit oil flow to a second component engine cylinder head to approximately what is necessary for that second component.

Variation 57 may include a method, and/or a product as set forth in any of Variations 1-56 wherein the bead connects two offset sections of the bore 14 of the head gasket

Variation 58 may include a method, and/or a product as set forth in any of Variations 1-57 wherein the frame comprises the rear interior of a vehicle trim.

Variation 59 may include a method, as set forth in any of Variations 1-58 wherein the method further includes providing fluid flow through the bead and bore wherein the bead is constructed and arranged to control the amount of fluid between a first location and a second location in or on at least one component.

Variation 60 may include a method, and/or a product as set forth in any of Variations 1-59 wherein the method further includes providing a second component fluidly connected to the bead, and providing fluid flow to the bead from a third location located in or on the second component.

Variation 61 may include a method, and/or a product as set forth in any of Variations 1-60 wherein the first component may be in contact with and/or fluid communication with the second component.

Variation 61 may include a method, and/or a product as set forth in any of Variations 1-60 wherein the second component may be formed or otherwise machined to form a compartment to accept the bead of the first component.

The above description of select examples of the invention is merely exemplary in nature and, thus, variations or variants thereof are not to be regarded as a departure from the spirit and scope of the invention.

What is claimed is:

1. A product comprising:
a fluid control system comprising at least one bore and at least one bead, wherein the bead is constructed and arranged to control the amount of fluid between a first location and a second location in or on at least one component.

2. A product as set forth in claim 1 wherein said bead comprises a hollow half cylinder.

3. A product as set forth in claim 1 wherein the radius of said bead is greater than a ¼ millimeter.

4. A product as set forth in claim 1 wherein said bead comprises multiple branches.

5. A product as set forth in claim 1 wherein said bead has a smaller radius than the radius of the bore.

6. A product as set forth in claim 1 wherein said bead is tapered along its length

7. A product as set forth in claim 1 wherein said component is an engine head gasket.

8. A product as set forth in claim 7 wherein said bore is drilled into said gasket.

9. A product as set forth in claim 7 wherein said bead is formed on the top surface of said gasket.

10. A product as set forth in claim 7 wherein said gasket comprises multiple layers.

11. A method comprising:
providing at least one component comprising a bore and a bead;
providing fluid flow through the bore and the bead wherein the bead is constructed and arranged to control the amount of fluid between a first location and a second location in or on at least one component.

12. A method as set forth in claim 11 further comprising:
providing a second component fluidly connected to the bead;
providing fluid flow from the bead to a third location located in or on the second component.

13. A method as set forth in claim 11 wherein said bead comprises a hollow half cylinder.

14. A method as set forth in claim 11 wherein the radius of said bead is greater than a ¼ millimeter.

15. A method as set forth in claim 11 wherein said bead comprises multiple branches.

16. A method as set forth in claim 11 wherein said bead has a smaller radius than the radius of the bore.

17. A method as set forth in claim 11 wherein said bead is tapered along its length

18. A method as set forth in claim 11 wherein said first component is an engine head gasket.

19. A method as set forth in claim 17 wherein said bore is drilled into said gasket.

20. A method as set forth in claim 17 wherein said bead is formed on the top surface of said gasket.
